(19) United States
(12) Patent Application Publication
(10) Pub. No.: US 2006/0279432 A1
(43) Pub. Date: Dec. 14, 2006

(54) Information generating device, information generating method, information generating program and storing medium storing the program

(75) Inventor: Kouji Mori, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); INCREMENT P CORPORATION, Tokyo (JP)

(21) Appl. No.: 11/437,840

(22) Filed: May 22, 2006

(30) Foreign Application Priority Data
May 23, 2005 (JP) 2005-150175

(51) Int. Cl. G08G 1/123

(52) U.S. Cl. 340/990; 701/212; 340/995.15

(57) ABSTRACT

The processor 150 of the map information generating device 100 sets the final locatable position of the annotation character string of the road number in the scales 1, 2, 3 and 4 at a position so as to be aligned with the commonly-numbered link recognized to have a common road number and such that at least one annotation character string is displayed in the display area with a road. The processor 150 generates the annotation data by applying the settings of the final locatable positions of the annotation character strings of the road number and operates the storage section 130 to store the generated annotation data.

### BACKGROUND OF THE INVENTION

1. Field of the Invention

The present invention relates to an information generating device, an information generating method, an information generating program and a storing medium storing the program, the information generating device generating moving-path-related information for displaying moving path detail information relating details of a moving path together with the moving path displayed in a display area in different scales.

2. Description of Related Art

A navigation device of the prior art is known, which displays a map of a present position of a vehicle and the vicinity thereof in a bird's-eye view (see, for example, Document 1: Japanese Patent Publication No. 3402011 (from the left column on page 2 to the right column on page 3, and FIG. 5)). Another navigation device is also known, which displays a name of a road on which a vehicle is running near an icon indicating a present position of a vehicle (see, for example, Document 2: Japanese Patent Publication No. 2928404 (from the right column on page 2 to the right column on page 3, and FIG. 4)).

The navigation device disclosed in Document 1 extracts a route on which the vehicle is currently running and a route on which the vehicle can subsequently run from a road map database. The device also reads character data relating to these routes and display position data of the character data from the road map database. Characters to be displayed are aligned with a direction of a road link nearest a display position and moved apart from the road link in a vertical direction to eliminate its overlapping on the road link. The characters are displayed at the thus-determined display position in the road map of a bird's-eye view on the screen.

The navigation device disclosed in Document 2 reads map data of an area around the present position of the vehicle from a map data storage such that the area is larger than a display area of the screen, and scrolls the thus-read map to display in line with the movement of the vehicle. When it is recognized that the map area being displayed includes a national road and the vehicle is running thereon, a road number of the national road is extracted from a road layer of the map data. Then, a road number image of the road number is generated, and the image is displayed near the icon indicating the vehicle position.

With the arrangement of Document 1, the display position of the road name of the map information is usually set by a map information creator, which causes problems such as that setting an locatable position for each road name is burdensome. According to the arrangement of Document 1, when a predetermined area map can be displayed in the display area in different scales, the road name may be displayed based on its display position information of the map information which corresponds to one scale. Hence, the road names may not be appropriately displayed in the display area, because, when the map is displayed in a larger scale, the road names are also displayed in an enlarged manner at a wider display interval. This is an example of disadvantages of the arrangement disclosed in Document 1. Additionally, with the arrangement of Document 2, the device needs to be capable of recognizing the present position of the vehicle, which makes an arrangement for displaying the road name complicate. This is another example of disadvantages of the arrangement disclosed in Document 2.

### SUMMARY OF THE INVENTION

An object of the present invention is to provide an information generating device, an information generating method, an information generating program and a storing medium storing the program, the information generating device appropriately generating moving-path-related information for displaying moving path detail information relating details of a moving path together with the moving path displayed in a display area in different scales.

An information generating device of the present invention is for generating moving-path-related information for displaying moving path detail information relating to details of a moving path. The moving path detail information is displayed relative to the moving path that is displayed in different scales in a display area. The information generating device includes: an identifying section for identifying the moving path of which details are shown by the predetermined moving path detail information; a moving path position recognizer for recognizing a display position in the different scales of the moving path identified by the identifying section; a detail position setting section for setting the display position in the different scales of the moving path detail information of the moving path identified by the identifying section such that at least one of the moving path detail information is aligned and displayed with the moving path in the display area; and a moving-path-related information generating section for generating the moving-path-related information for displaying the moving path detail information at the display position set by the detail position setting section.

An information generating method of the present invention is for generating moving-path-related information for displaying moving path detail information relating to details of a moving path. The moving path detail information is displayed relative to the moving path that is displayed in different scales in a display area with a computing unit. The information generating method including: identifying the moving path of which details are shown by the moving path detail information, recognizes a display position of the identified moving path in the different scales, setting the display position of the moving path detail information of the identified moving path in the different scales at a position such that at least one of the moving path detail information is aligned and displayed with the moving path, and generating the moving-path-related information for displaying the moving path detail information at the set display position.

An information generating program of the present invention operates a computing unit as the above described information generating device.

An information generating program of the present invention operates a computing unit to execute the above described information generating method.

A storing medium storing the information generating program of the present invention stores the above described information generating program readably by the computing unit.

### BRIEF DESCRIPTION OF THE DRAWINGS

FIG. 1 is a block diagram schematically showing an arrangement of a map information generating device of an embodiment according to the present invention;

FIG. 2 is a conceptual diagram schematically showing a table structure of display data of map information of the embodiment;

FIG. 3 is a conceptual diagram schematically showing a table structure of matching data of the map information of the embodiment;

FIG. 4 is a view schematically showing an arrangement of a link information table of the embodiment;

FIG. 5 is a view schematically showing an arrangement of a node information table of the embodiment;

FIG. 6 is a view schematically showing an arrangement of annotation data of the embodiment;

FIG. 7 is a view schematically showing a final locatable position of a annotation character string of a road number in an area that is displayed in a scale 1 of the embodiment;

FIG. 8 is a view schematically showing the final locatable position of the annotation character string of the road number in an area that is displayed in a scale 2 of the embodiment;

FIG. 9 is a view schematically showing the final locatable position of the annotation character string of the road number in an area that is displayed in a scale 3 of the embodiment;

FIG. 10 is a view schematically showing the final locatable position of the annotation character string of the road number in an area that is displayed in a scale 4 of the embodiment;

FIG. 11 is a view of the embodiment, which schematically shows a tentative locatable position and the final locatable position of the annotation character string of the road number in a case where an overlapped existing annotation exists relative to the annotation character string;

FIG. 12 is a view schematically showing the final locatable position of the annotation character string of the road name in the area that is displayed in a scale 1 of the embodiment;

FIG. 13 is a flowchart showing a generating process of the annotation data relating to the road number of the embodiment;

FIG. 14 is a flowchart showing a setting process of the final locatable position of the road number of the embodiment;

FIG. 15 is a flowchart showing a generating process of the annotation data relating to the road name of the embodiment; and

FIG. 16 is a flowchart showing a setting process of the final locatable position of the road name of the embodiment.

### DETAILED DESCRIPTION OF PREFERRED EMBODIMENT(S)

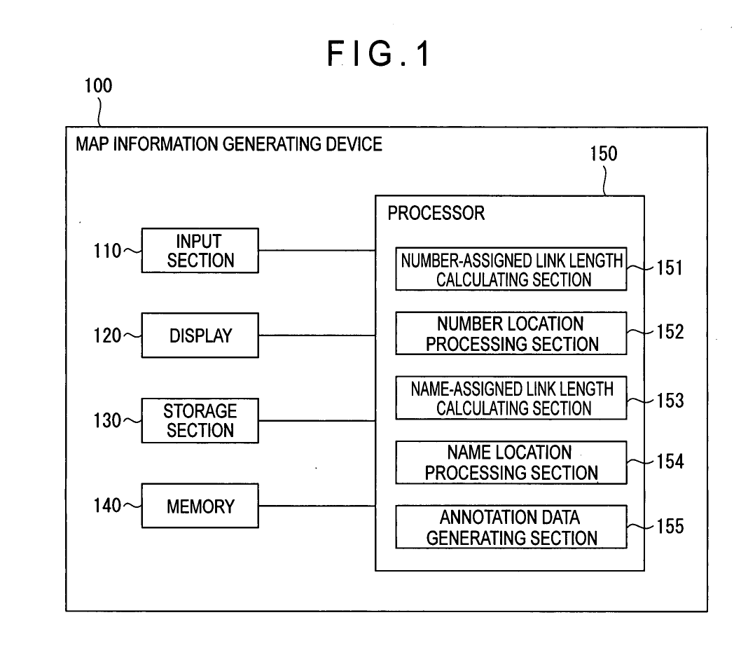

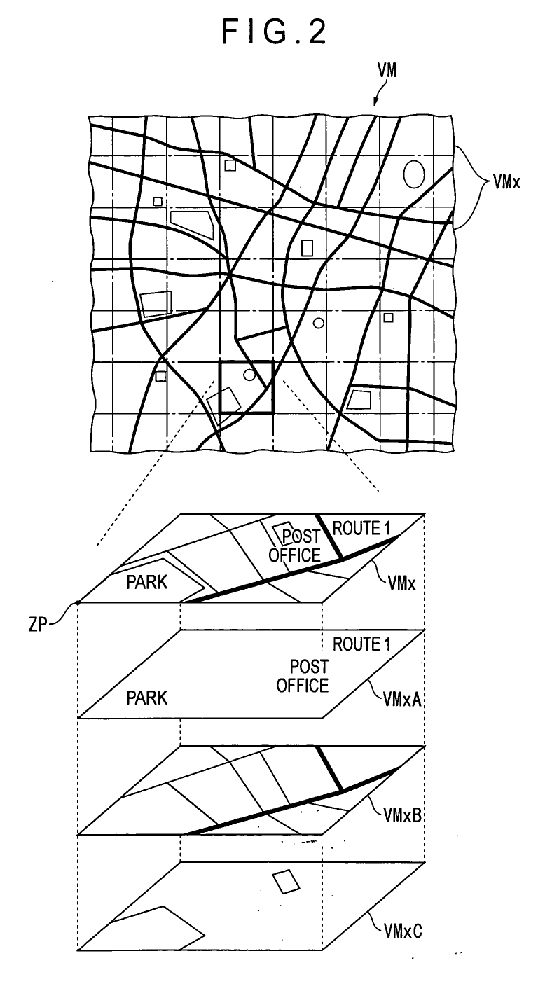

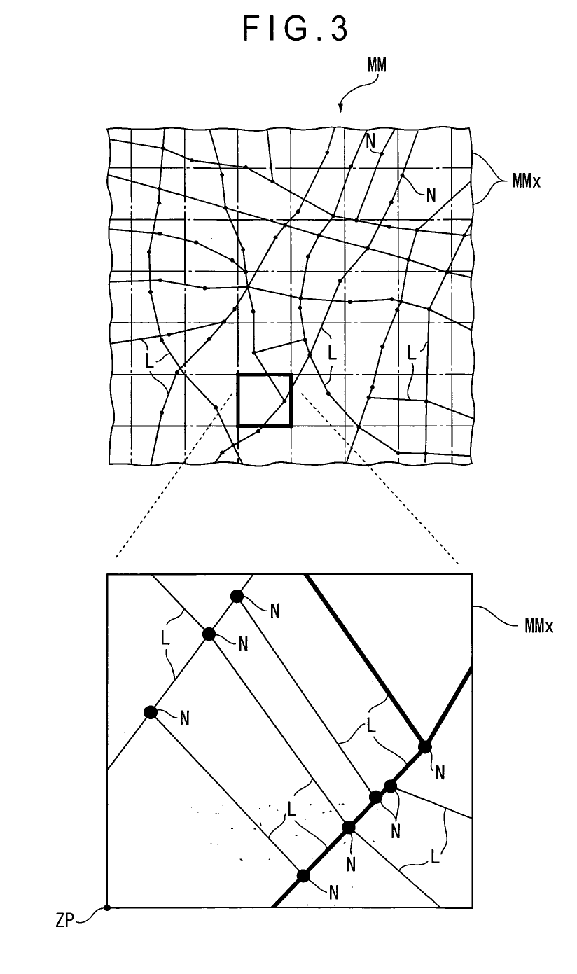

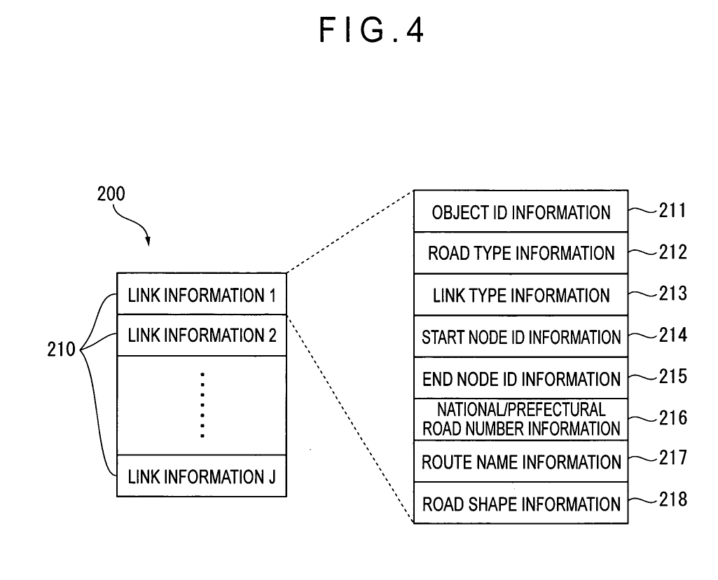

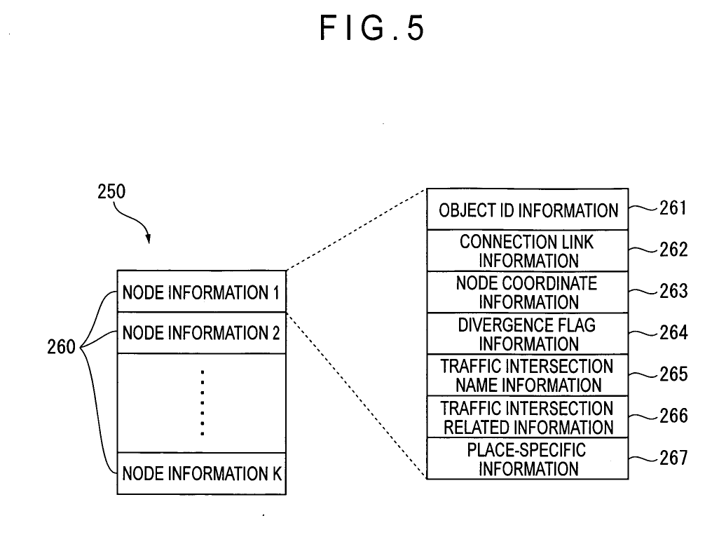

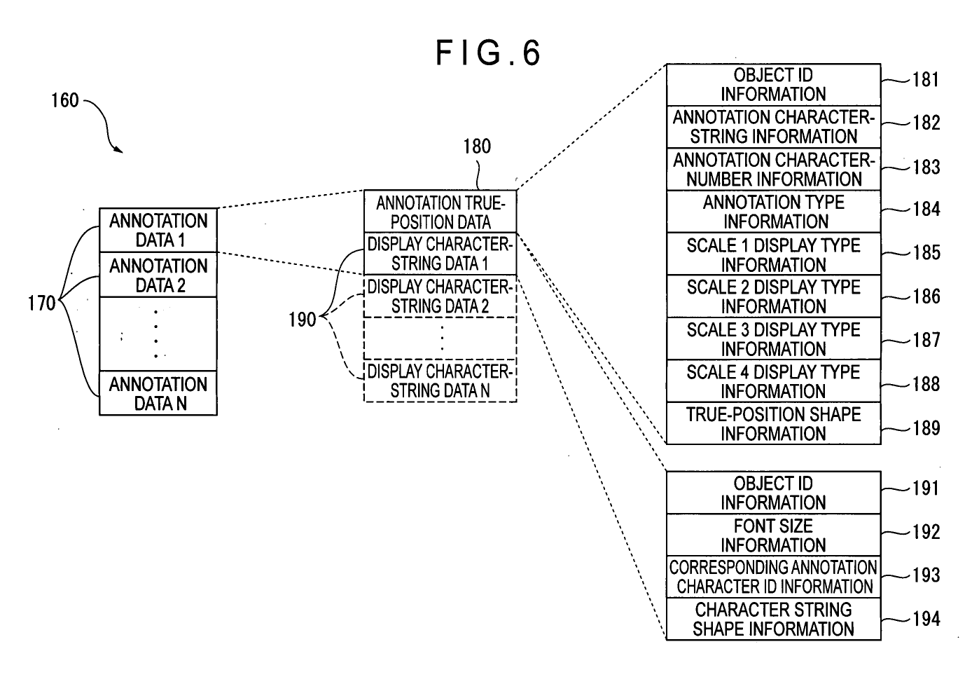

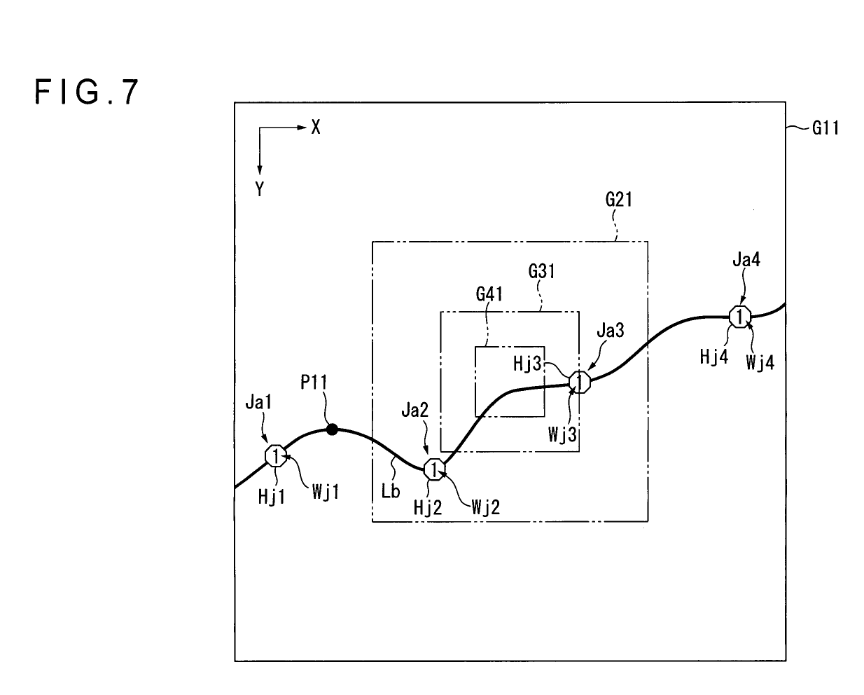

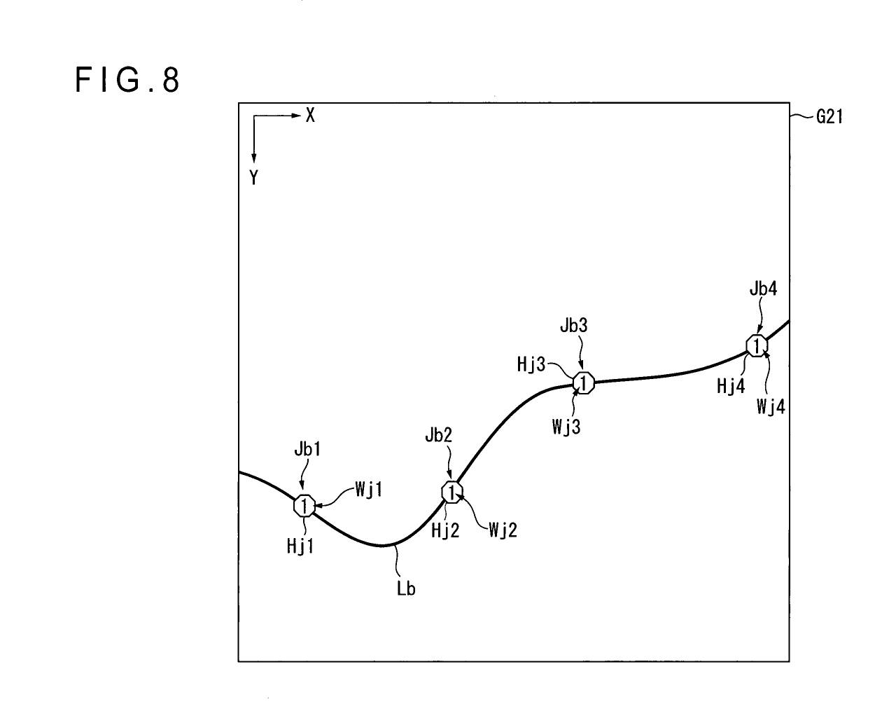

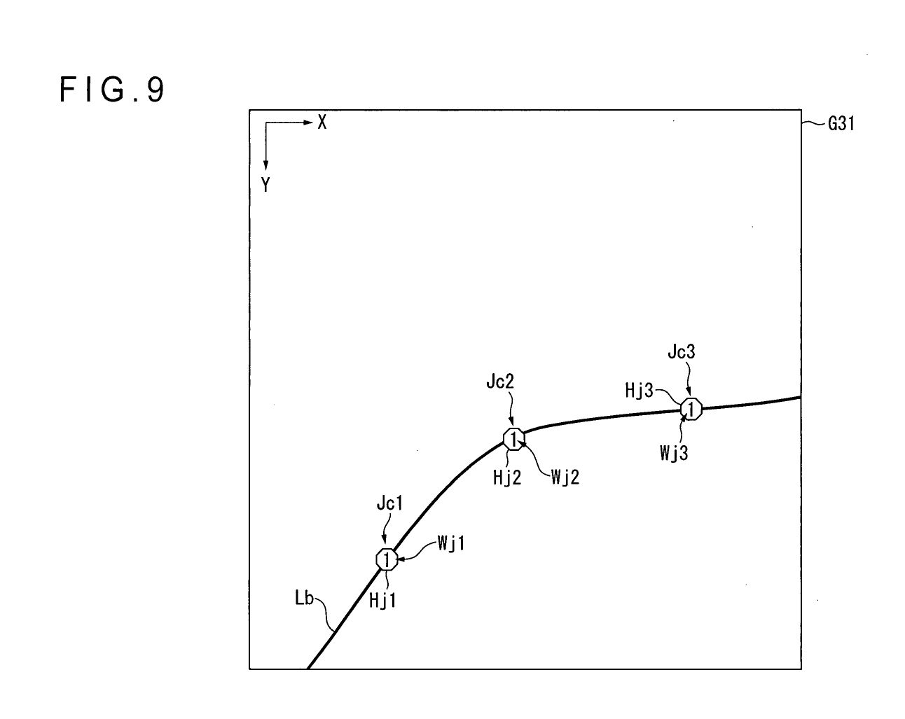

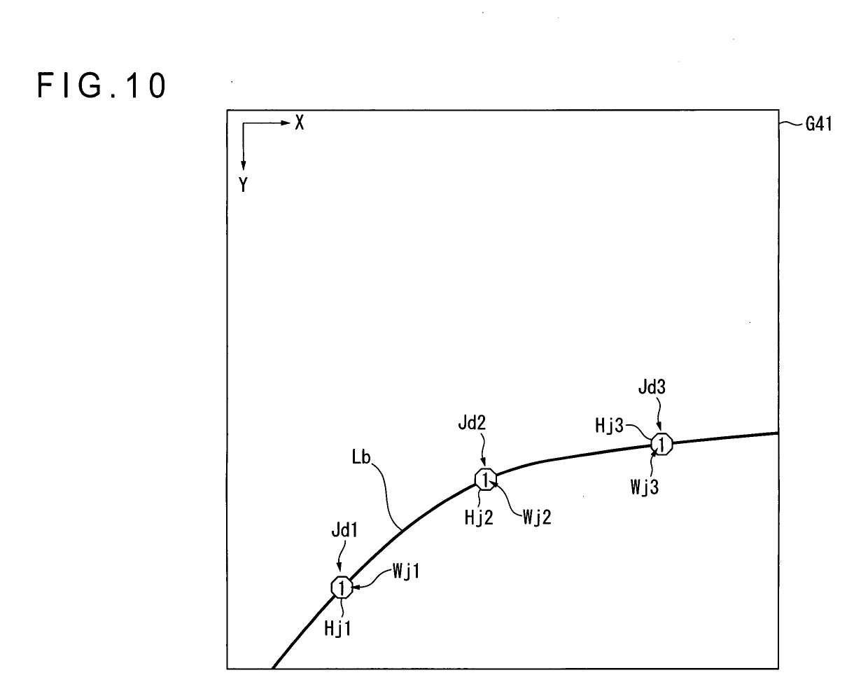

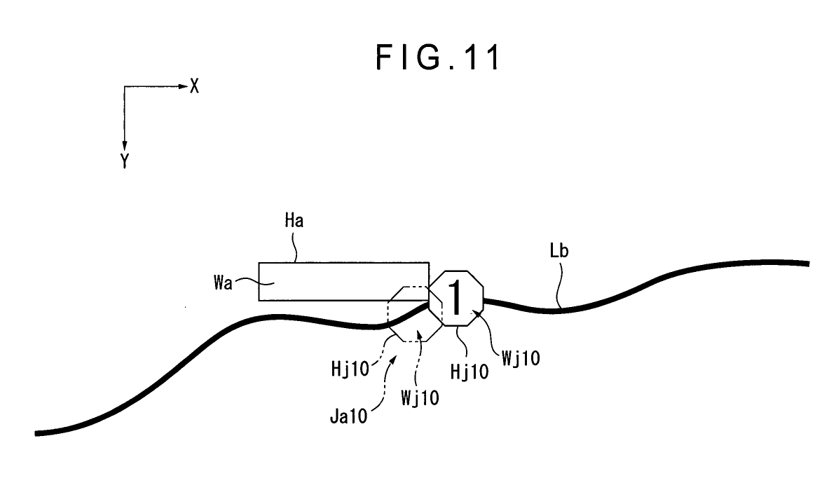

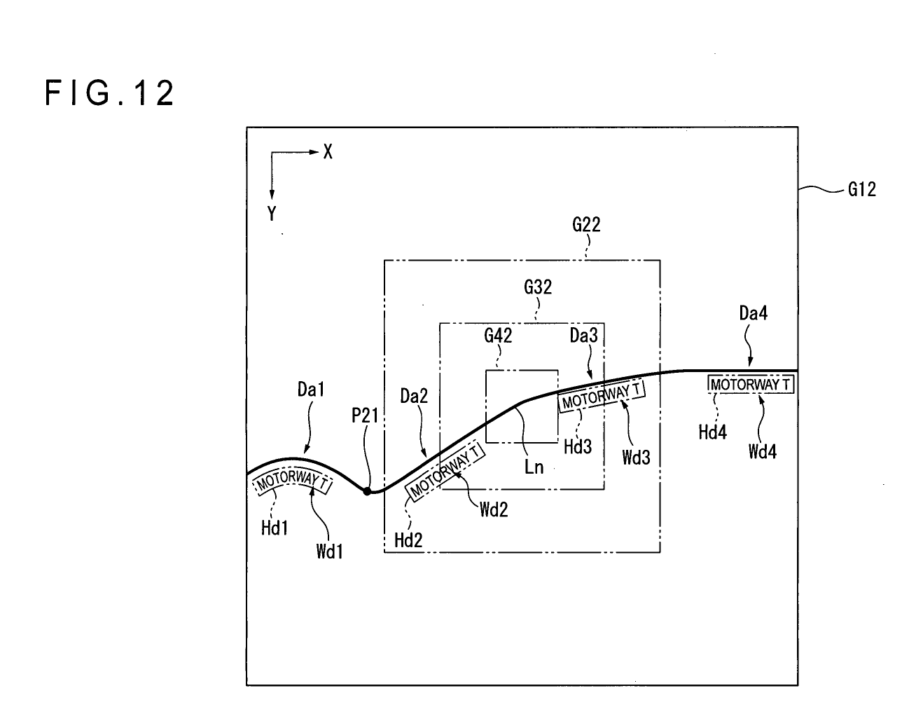

An embodiment of the present invention will be described below with reference to the attached drawings. In the particular embodiment, the invention will be explained by exemplifying a map information generating device as an information generating device of the invention, which generates map information to display a map on a display unit mounted in a mobile body such as a vehicle. FIG. 1 is a block diagram schematically showing an arrangement of the map information generating device. FIG. 2 is a conceptual diagram schematically showing a table structure of display data of the map information. FIG. 3 is a conceptual diagram schematically showing a table structure of matching data of the map information. FIG. 4 is a view schematically showing an arrangement of a link information table. FIG. 5 is a view schematically showing an arrangement of a node information table. FIG. 6 is a view schematically showing an arrangement of annotation data. FIG. 7 is a view schematically showing a final locatable position of a annotation character string of a road number in an area displayed in the scale 1. FIG. 8 is a view schematically showing the final locatable position of the annotation character string of the road number in an area displayed in the scale 2. FIG. 9 is a view schematically showing the final locatable position of the annotation character string of the road number in an area displayed in the scale 3. FIG. 10 is a view schematically showing the final locatable position of the annotation character string of the road number in an area displayed in the scale 4. FIG. 11 is a view schematically showing a tentative locatable position and the final locatable position of the annotation character string of the road number in a case where an overlapped existing annotation on the annotation character string exists. FIG. 12 is a view schematically showing the final locatable position of the annotation character string of a road name in the area displayed in the scale 1.

[Arrangement of Map Information Generating Device]

In FIG. 1, a map information generating device is denoted by a reference numeral 100. The map information generating device 100 generates map information for displaying various kinds of information relating to features (target objects such as facilities, factories and shops) and traffic intersections, and a road number and a road name of a road (a moving path) in a display area of a display unit (not shown) together with roads as a map. The map information generating device 100 includes an input section 110, a display 120, a storage section 130, a memory 140 and a processor 150 (a computing unit).

The input section 110 has a variety of operation buttons and knobs (not shown) for input. Inputs with the operation buttons and knobs include operation settings of the map information generating device 100. Specifically, a variety of settings for generating the map information and conducting a search for various kinds of information can be exemplified. In accordance with the inputs, the input section 110 outputs a predetermined signal to the processor 150 to apply the settings.

The display 120 displays signals of image data sent by the processor 150 under the control of the processor 150. The display 120 may be a liquid crystal panel, an organic EL (Electro Luminescence) panel, a PDP (Plasma Display Panel), a CRT (Cathode-Ray Tube), an FED (Field Emission Display) or an electrophoretic display panel. The image data displayed on the display 120 includes maps based on the information relating to the features and traffic intersections or based on the map information stored in the storage section 130.

The storage section 130 stores the map information shown in FIGS. 2 and 3, a link information table 200 shown in FIG. 4, a node information table 250 shown in FIG. 5 and the like in a readable manner. The storage section 130 may be provided with a drive or a driver that readably stores data in a recording medium such as an HD (Hard Disk), a DVD (Digital Versatile Disc), an optical disc and a memory card.

The map information includes display data VM, i.e. so-called POI (Point Of Internet) data as shown in FIG. 2, matching data MM as shown in FIG. 3 and symbol-related information (not shown).

The display data VM includes plural pieces of display mesh information VMx, each having a unique number. In other words, the display data VM is divided into the plural pieces of display mesh information VMx, each piece relating to an area. The plural pieces of display mesh information are arranged continuously in a matrix form. Note that, the display mesh information VMx may be further divided into plural pieces of display mesh information VMx forming a lower layer, each relating to an area. The display mesh information VMx each have a rectangular shape including a preset side length obtained by scaling an actual geographic distance based on the map scale. A predetermined corner of the rectangular shape is assigned with information of absolute coordinates ZP in the whole map information such as a global map.

The display mesh information VMx is constituted of name information VMxA, road information VMxB and background information VMxC. The name information VMxA is formed in a data table structure for displaying miscellaneous element data of the area i.e. annotations on the features and traffic intersections such as a traffic intersection name or a place name, at a predetermined position in positional relationship to the absolute coordinates ZP. The annotations include a symbol to be located on a position of a feature (hereinafter referred to as a true position) with the true position at the center thereof, a annotation character string for an explanation, a name or details of the feature to be located at the true position or at a position apart from the true position, an instruction point to be located with the true position at the center thereof, a leader line connecting the instruction point and the annotation character string. As shown in FIG. 6, the name information VMxA includes annotation list data 160 having plural pieces of annotation data 170 as moving-path-related information.

The annotation data 170 is information for displaying the annotation. The annotation data 170 includes annotation true-position data 180 and display character-string data 190. Note that, the annotation data 170 may not include any display character-string data 190 or may include plural pieces of display character-string data 190.

The annotation true-position data 180 is information for appropriately displaying the annotation. The annotation true-position data 180 forms a data structure constituted of object ID (Identification) information 181, annotation character-string information 182 also functioning as moving path detail information and target object detail information, annotation character-number information 183, annotation type information 184, scale 1 display type information 185, scale 2 display type information 186, scale 3 display type information 187, scale 4 display type information 188, true-position shape information 189 or the like.

The object ID information 181 is unique information for identifying the annotation true-position data 180. The annotation character-string information 182 is information for displaying the annotation character string on the map. Specifically, in the annotation character-string information 182, character information for showing the characters is stored, including a place name “MKWAKWANI”, a traffic intersection name “AB town, C district” and a building name “CD hospital.” Note that, when the character information for displaying the road number by a figure is stored in the annotation character-string information 182 and a type (or a class) stored in the annotation type information 184 is the road number, the figure is appropriately displayed on the display unit, overlapping on a graphic such as a triangle, hexagon or octagon. When the type of the annotation type information 184 is the road number, a display type is set to either later-described non-display type or symbol display type. Hence, the figure indicating the road number is appropriately displayed as a symbol together with a graphic.

The annotation character-number information 183 is information on the number of characters of the annotation character string that is displayed based on the annotation character-string information 182. The annotation type information 184 is information on the type (or class) of the annotation corresponding to the annotation true-position data 180. Specifically, in the annotation type information 184, information showing the annotation type is stored, including airports, police stations, universities, shrines, names of subway lines, major traffic intersections, road numbers, urban expressways, and names of highways and national roads.

The scale 1 display type information 185 is information on the display type of the annotation, when the map scale is, for example, 1 to 100,000 (hereinafter referred to as a scale 1). Specifically, in the scale 1 display type information 185, information on to which the display type is set i.e. non-display type, character display type, symbol-character display type, leader-character display type or symbol display type. The non-display type is for not displaying the annotation. The character display type is for displaying only the annotation character string. The symbol-character display type is for displaying both the symbol and the annotation character string. The leader-character display type is for displaying the annotation character string, the instruction point and the leader line. The symbol display type is for displaying only the symbol. The scale 2 display type information 186 is information on the display type of the annotation, when the map scale is, for example, 1 to 50,000 (hereinafter referred to as a scale 2). The scale 3 display type information 187 is information on the display type of the annotation, when the map scale is, for example, 1 to 25,000 (hereinafter referred to as a scale 3). The scale 4 display type information 188 is information on the display type of the annotation, when the map scale is, for example, 1 to 12,500 (hereinafter referred to as a scale 4).

The display types of the scale 1 display type information 185, the scale 2 display type information 186, the scale 3 display type information 187 and the scale 4 display type information 188 are set in correspondence with the type of the annotation type information 184. Specifically, when the type of the annotation type information 184 is an airport, the display type is set to the symbol-character display type in the scales 1, 2, 3 and 4. When the type thereof is police stations, the display type is set to the non-display type in the scale 1 and to the symbol display type in the scales 2, 3 and 4. When the type thereof is road numbers, the display type is set to the non-display type or the symbol display type as mentioned above in the scales 1, 2, 3 and 4. When the type thereof is road names, the display type is set to the non-display type or the character display type in the scales 1, 2, 3 and 4. Note that, the scales of the scales 1, 2, 3 and 4 are not limited to those exemplified above, but may be other appropriate scales.

The true-position shape information 189 is information on the true position on the map. Specifically, in the true-position shape information 189, information on a latitude and a longitude that correspond to the true position is stored as, for example, an x-coordinate and a y-coordinate.

The display text string data 190 is information for displaying the annotation at a predetermined position. The display text string data 190 forms a data structure constituted of object ID information 191, font size information 192, corresponding annotation character ID information 193, character string shape information 194 as detail position information, or the like.

The object ID information 191 is unique information for identifying the display text string data 190. The font size information 192 is information on a font size of the annotation character string displayed on the map. Note that, the font size information 192 may not be incorporated in the display text string data 190, when all the display types of the scales 1, 2, 3 and 4 are set so as not to display the annotation character string, i.e. the non-display type or the symbol display type. Alternatively, the font size information 192 may include information on the font size corresponding to the type of the annotation type information 184. The corresponding annotation character ID information 193 is unique information of the annotation true-position data 180, the information corresponding to the display text string data 190. That is, the corresponding annotation character ID information 193 is the same information as that in the object ID information 181.

The character string shape information 194 is information on a position of a character area of the annotation character string of which font size is set by the font size information 192 as well as a position of the leader line. Specifically, the character string shape information 194 includes information on coordinates of vertexes of the character area and the leader line. For example, when the character area has a rectangular shape, coordinates of the four vertexes are stored. When the character area has a curved shape, coordinates representing the curved shape such as those of a curved position are stored. When the type stored in the annotation type information 184 is road numbers, coordinates identifying the outline of a graphic enclosing the road number are stored. For example, when the graphic is a polygon, coordinates of the vertexes are stored. When the leader line has a triangular shape, coordinates of the three vertexes are stored. Additionally, coordinates of the character areas respectively corresponding to the scales 1, 2, 3 and 4, each being set to either of the display type of the character display type, the symbol-character display type or the leader-character display type are stored. Concretely, when the scale 1 is the non-display type and the scales 2, 3 and 4 are the character display type, each character string shape information 194 includes coordinates of the character area corresponding to the scale 2, 3 or 4. Coordinates of the leader lines respectively corresponding to the scales 1, 2, 3 and 4 all of which display type are set to the leader-character display type are also stored. Note that, when the character area or the leader line has a rectangular shape, only coordinates of the two vertexes at both ends of one of the diagonal lines may be stored.

The road information VMxB is formed in a table structure for displaying roads as road element data of the area, at a predetermined position in positional relationship to the absolute coordinates ZP. The background information VMxC is formed in a table structure for displaying an icon indicating a well-known place or building (miscellaneous element data) and image information of the well-known place or building (miscellaneous element data), at a predetermined position in positional relationship to the absolute coordinates ZP.

The matching data MM is, similarly to the display data VM, divided into plural pieces of matching mesh information MMx, each relating to an area and being assigned with a unique number. The plural pieces of matching mesh information MMx are arranged continuously in a matrix form. Note that, the matching mesh information MMx may be further divided into plural pieces of matching mesh information MMx forming a lower layer, each relating to an area. The matching mesh information MMx each have a rectangular shape including a preset side length obtained by scaling an actual geographic distance based on the map scale. A predetermined corner of the rectangular shape is assigned with information of absolute coordinates ZP in the whole map such as a global map. Note that, the matching mesh information MMx may have a data structure for showing an area different from the display mesh information VMx. The information MMx may have different scales for dividing the area. When the scales are the same, the data can be associated with each other by using unique numbers. On the other hand, when the scales are different, the data can be associated by using absolute coordinates. The matching data MM has plural pieces of link line block information.

As shown in FIG. 3, the link line block information has a table structure of data, in which a plurality of links L (lines connecting nodes N) are associated by a predetermined rule, the nodes N constituting roads and representing site points. Specifically, the links L each corresponding to a predetermined length of a road are mutually associated to form polygonal lines (i.e. link lines), which represent continuous roads such as Koshu street and Ome street. The link L has a link ID uniquely assigned thereto.

The node N represents a nodal point such as a traffic intersection, a folding point, a diverting point, a junction or the like of the road. Each node N of the link string block information has a node ID that is a number uniquely assigned thereto.

As shown in FIG. 4, the link information table 200 is formed in a table structure in which plural pieces of link information 210 are stored. The plural pieces of link information 210 are respectively associated with the links L of the above described link string block information. The link information 210 forms a data structure constituted of object ID information 211, road type information 212, link type information 213, start node ID information 214 as connection node identification information, end node ID information 215 as connection node identification information, national/prefectural road number information 216, route name information 217, road shape information 218 and the like.

The object ID information 211 is unique information associated with the link ID of the link L and is used for identifying the link information 210. The object ID information 211 includes the link ID of the link L and identifies the link L corresponding to the link information 210. Note that, the object ID information 211 requires information for identifying each link L, and may include coordinates of the link L instead of the link ID. The road type information 212 is information on the type (or class) of the road that corresponds to the link L identified by the object ID information 211. Specifically, in the road type information 212, flag information is stored, such as whether the link L is a toll road or not, a main line or not, a national road or a prefectural road, a one-way road or not, or a tunnel or not. In addition, information on a zone distance of the link L, speed limits and the like may be stored. The link type information 213 is information on the type (or class) of the link L identified by the object ID information 211. Specifically, in the link type information 213, information is stored, such as whether or not the link L is a short link for representing a connection of the links L in a traffic intersection (hereinafter referred to as an in-traffic-intersection link), whether or not the link L represents a road that has a separate up lane and down lane, or whether or not the link L is a dedicated short link L for representing a right turn or left turn.

The start node ID information 214 is information for identifying the node N located at a start point of the link L that is identified by the object ID information 211 in the link string block information. The start node ID information 214 includes, for example, the node ID of the node N located at the start point of the link L. Note that, the start node ID information 214 may include coordinates or an address of the node N. The end node ID information 215 is information for identifying the node N located at an end point of the link L that is identified by the object ID information 211 in the link string block information. The end node ID information 215 includes similar information to the start node ID information 214.

The national/prefectural road number information 216 is information for displaying, when the road corresponding to the link L identified by the object ID information 211 is a prefectural road or a national road, a number assigned to the prefectural or national road numerically like “1” or “14”. The route name information 217 is information for displaying, when the road corresponding to the link L identified by the object ID information 211 is assigned with a unique name, the name such as Ome street. The road shape information 218 is information on a shape of a road that corresponds to the link L identified by the object ID information 211. Specifically, in the road shape information 218, information such as a width of a road, the number of traffic lanes thereof, whether or not the road has a center divider, or whether or not the road has a foot pavement is stored.

As shown in FIG. 5, the node information table 250 is formed in a table structure in which plural pieces of node information 260 are stored. The node information 260 is information associated with each node N of the link string block information. The node information 260 forms a data structure constituted of object ID information 261, connection link information 262, node coordinate information 263 as coordinate information, divergence flag information 264, traffic intersection name information 265, traffic intersection related information 266, place-specific information 267 or the like that are associated to each other.

The object ID information 261 is unique information that is associated with the node IDs of the nodes N at the both ends of the link L to be used for identifying the node information 260. The object ID information 261 includes the node ID and identifies the link L corresponding to the node information 260 of the object ID information 261. Note that, the object ID information 261 may include information on coordinates of the node N for identifying the node N. The connection link information 262 is information on the link L connected to the node N identified by the object ID information 261. The connection link information 262 includes link ID of the link L that is connected to the node N.

The node coordinate information 263 is information on a position of the node N identified by the object ID information 261. The node coordinate information 263 includes information on a latitude and longitude of the node N on the map information, which are indicated as, for example, an x-coordinate and a y-coordinate. Note that, in addition to the information of the x-coordinate and the y-coordinate, an address of the node N may be stored. The divergence flag information 264 is flag information showing whether or not the node N identified by the object ID information 261 is a traffic intersection. In the divergence flag information 264, “0” is stored when the node N merely represents a site point, and “1” is stored when the node N represents a traffic intersection. Note that, the divergence flag information 264 may not be provided. In this case, the arrangement may be that the node N is judged to be a traffic intersection using the connection link information 262, when the node N is connected to more than two links L.

The traffic intersection name information 265 is information on a traffic intersection name stored, when the node N is a traffic intersection and “1” is stored in the divergence flag information 264 of the node N. The traffic intersection related information 266 is detail information of the traffic intersection, which is stored when the node N represents a traffic intersection. In the traffic intersection related information 266, various kinds of information are stored, such as information relating to right/left turns of the traffic intersection of the node N, whether or not the traffic intersection has a right-turn lane or a left-turn lane, or whether or not the traffic intersection has a traffic signal. Note that, the arrangement may be that only the information relating to the traffic intersection name is stored in the traffic intersection related information 266 and the traffic intersection name information 265 is not included in the node information 260. The place-specific information 267 is information relating to the name of the node N identified by the object ID information 261. In the place-specific information 267, information such as a name of a place or noticeable building is stored.

The symbol-related information is information relating to symbols. The symbol-related information forms a data structure constituted of symbol information, symbol type information, symbol shape size information or the like. Note that, the symbol-related information may have a data structure that does not include the symbol information.

The symbol information is information for displaying symbols. The symbol type information is information on the type (or class) of the feature shown by the symbol information. Specifically, in the symbol type information, the same information as the annotation type information 184 of the annotation true-position data 180 is stored. The symbol shape size information is information on a shape size of a symbol to be displayed. Specifically, in the symbol shape size information, a shape size of the symbol is stored, the shape size shown, for example, using fonts that are units generally used for character size.

The memory 140 stores settings inputs via the input section 110 in a readable manner. The memory 140 also stores a variety of programs run on an OS (operating system) that controls the whole map information generating device 100. The memory 140 is preferably capable of retaining the content even when its power source is abruptly shut down due to a blackout or the like and may be a CMOS (Complementary Metal-Oxide Semiconductor) memory. Note that, the memory 140 may be provided with a drive or a driver that readably stores data in a recording medium such as an HD, a DVD and an optical disc.

The processor 150 has a variety of input/output ports (not shown) such as a key-input port connected to the input section 110, a display control port connected to the display 120, a storage port connected to the storage section 130, a memory port connected to the memory 140 or the like. As shown in FIG. 1, the processor 150 includes the various software applications such as a number-assigned link length calculating section 151 (a moving path length recognizer also functionable as an identifying section), a number location processing section 152 (a detail position setting section), a name-assigned link length calculating section 153 (a moving path length recognizer also functionable as an identifying section), a name location processing section 154 (a detail position setting section), a annotation data generating section 155 (a moving-path-related information generating section also functionable as a detail position information generating section).

The number-assigned link length calculating section 151 calculates a total length of the links L assigned with a common road number as a total link length that is an actual length of roads assigned with the common road number, based on the link information table 200 or the node information table 250. In the description below, when links L assigned with a common road number are collectively mentioned, the links L are referred to as commonly-numbered links Lb. Specifically, the number-assigned link length calculating section 151 obtains the link information 210 corresponding to a predetermined link L from the link information table 200. When recognizing that a road number is stored in the national/prefectural road number information 216 of the link information 210, the number-assigned link length calculating section 151 recognizes the link L corresponding to the link information 210 as a number-assigned link L corresponding to the link information 210. The number-assigned link length calculating section 151 calculates a length of the number-assigned links L as a subtotal link length of the commonly-numbered links Lb.

Possible calculating methods for calculating the length of the predetermined link L include a method described below. The node IDs of the nodes N respectively located at the start point and the end point of the link L are recognized based on the start node ID information 214 and the end node ID information 215 of the link information 210 in order to obtain the node information 260 in which the recognized node IDs are stored in the object ID information 261. The length of the link L may be calculated based on the coordinates of the nodes N stored in the node coordinate information 263 of the thus obtained node information 260. Note that, when a zone distance of the link L is stored in the road type information 212, a length corresponding to the zone distance may be recognized as the length of the link L.

The number-assigned link length calculating section 151 recognizes the link L in connection with the number-assigned link L based on the connection link information 262 corresponding to the nodes N respectively located at the start point and the end point of the number-assigned link L. Further, when recognizing that the link L in the connection has the common road number to that of the number-assigned link L based on the national/prefectural road number information 216 of the link L, the number-assigned link length calculating section 151 calculates a length by adding the length L of the link L in the connection to an already-calculated subtotal link length in order to obtain a new subtotal link length. When the predetermined link L is recognized to have the common road number to that of the number-assigned link L, the subtotal link length is calculated in the above described manner, while when the link L is recognized not to have the common road number to that of the number-assigned link L, the already-calculated subtotal link length is recognized as the total link length of the commonly-numbered links Lb.

The number location processing section 152 sets an locatable position of the annotation character string of the road number of the commonly-numbered link Lb, based on the total link length of the commonly-numbered links Lb having the predetermined road number, the already-set locatable position of the annotation being related to shops or the like (hereinafter, referred to as an existing annotation). Specifically, the number location processing section 152 judges whether or not the total link length of the commonly-numbered links Lb is longer than a first, second, third or fourth location interval respectively set to the scales 1, 2, 3 and 4.

The first, second, third and fourth location intervals are set such that an actual length of a road is, for example, 4 km, 2 km, 1 km and 500 m respectively. That is, each length in the display area of the scale 1, 2, 3 or 4 is set to be 4 cm. The display units for vehicles usually have a display area of 6.5 inch or bigger. In other words, a short side of the rectangular display area is 7.7 cm or longer. Accordingly, at least one of the annotation character strings of the road number located with the first, second, third and fourth location intervals i.e. located with the 4 cm interval is displayed in the display area together with the road. Note that, the location interval is not limited to the above exemplified length, but may be any appropriate length as long as at least one annotation character string of the road number is displayed in the display area. For example, in a case of the display units having display areas bigger than those of the display units for vehicles such as screens of personal computers used at home, the location interval may be set longer than the above exemplified length. In another case in which the display units have display areas smaller than those of the display units for vehicles such as screens of mobile phones, the location interval may be set shorter than the above exemplified length. In addition, whether or not the total link length is longer than a length obtained by adding a certain length shorter than the first, second, third and fourth location intervals to the first, second, third and fourth location intervals may be judged.

When judging that the total link length is longer than, for example, the first location interval, the number location processing section 152 recognizes that a plurality of the annotation character strings of the road numbers can be located on a commonly-numbered link Lb. For example, when the total link length is 5 km, the number location processing section 152 recognizes that two road numbers can be located at positions apart from each other with an interval corresponding to the first location interval of 4 km. When the total link length is 10 km, the number location processing section 152 recognizes that three road numbers can be located. In other words, the number location processing section 152 recognizes that the road numbers can be located by the number that is obtained by adding one to a value calculated by dividing the total link length by the first location interval and rounding decimal places. Note that, the number location processing section 152 may recognize that the road number can be located by the value thus obtained with decimal places rounded, or the number that is obtained by subtracting a predetermined value from the value with decimal places rounded. The number location processing section 152 sets tentative locatable positions of a plurality of annotation character strings of the road numbers at the first location interval on the commonly-numbered link Lb.

When judging that the total link length is shorter than, for example, the first location interval, the number location processing section 152 recognizes that only one annotation character string of the road number can be located on the commonly-numbered link Lb. The number location processing section 152 sets the tentative locatable position of the only one annotation character string of the road number at a predetermined position on the commonly-numbered link Lb such as the center of the commonly-numbered link Lb or a position in the vicinity of the start or end point on the commonly-numbered link Lb.

Further, the number location processing section 152 recognizes a shape of the character area of the annotation character string, based on the predetermined character number of the road number as well as on, for example, the font size and shape of the graphic enclosing the figure, the size and shape being predetermined. Then, the thus recognized character area is set so as to correspond to the tentative locatable position and to overlap on the commonly-numbered link Lb. For example, when an area G11 is displayed in the map scale of the scale 1 as shown in FIG. 7, an octagonal character area Hjt (t is a natural number) is set so as to correspond to a tentative locatable position Jat (t is a natural number) and to overlap on the commonly-numbered link Lb, the character area Hjt enclosing a annotation character string Wjt (t is a natural number) of the road number. When the area G21 as shown in FIG. 7 is displayed in the map scale of the scale 2, which is twice as large scale as the scale 1, a character area Hju (u is a natural number) of a annotation character string Wju (u is a natural number) is set so as to correspond to a tentative locatable position Jbu (u is a natural number) and to overlap on the commonly-numbered link Lb as shown in FIG. 8. When an area G31 as shown in FIG. 7 is displayed in the map scale of the scale 3, which is four times as large scale as the scale 1, a character area Hjv (v is a natural number) of a annotation character string Wjv (v is a natural number) is set so as to correspond to a tentative locatable position Jcv (v is a natural number) and to overlap on the commonly-numbered link Lb. When an area G41 as shown in FIG. 7 is displayed in the map scale of the scale 4, which is eight times as large scale as the scale 1, a character area Hjw (w is a natural number) of a annotation character string Wjw (w is a natural number) is set so as to correspond to a tentative locatable position Jdw (w is a natural number) and to overlap on the commonly-numbered link Lb.

The number location processing section 152 obtains the annotation data 170 of the existing annotation of, for example, a facility that stands near the commonly-numbered link Lb. When recognizing that there is an existing annotation overlapping on the annotation character string of the road number (hereinafter referred to as an overlapped existing annotation) based on the character string shape information 194 of the annotation data 170, the number location processing section 152 re-sets the tentative locatable position of the annotation character string of the road number to another position so as not to overlap on the overlapped existing annotation. And when setting the character area of the annotation character string so as to correspond to the tentative locatable position and to overlap on the commonly-numbered link Lb and recognizing that there is no overlapped existing annotations, the number location processing section 152 sets the tentative locatable position as the final locatable position. For example, when a annotation character string Wa of the existing annotation exists as the overlapped existing annotation relative to a annotation character string Wj10 of the road number that is provided with a tentative locatable position Ja10 and shown in the imaginary line as shown in FIG. 11, the number location processing section 152 sets a position to which the annotation character string Wj10 is moved by an overlapping amount of a character area Hj10 of the annotation character string Wj10 of the road number on a character area Ha of the annotation character string Wa as the final locatable position. Alternatively, a position to which the character area Hj10 is moved apart from the character area Ha by a predetermined distance may be set as the final locatable position.

As shown in FIGS. 7 to 10, when recognizing that there is no overlapped existing annotations relative to the annotation character string Wj1 to Wj4 of the road number, the annotation character string Wj1 to Wj4 respectively located at the tentative locatable positions Ja1 to Ja4, Jb1 to Jb4, Jc1 to Jc3 and Jd1 to Jd3, the number location processing section 152 sets the tentative locatable positions Ja1 to Ja4, Jb1 to Jb4, Jc1 to Jc3, and Jd1 to Jd3 as the final locatable positions. The annotation character string Wjt of the road number located at the final locatable position is displayed on the display unit in a manner overlapping on the road corresponding to the commonly-numbered link Lb.

As described above, the first, second, third and fourth location intervals are respectively set to 4 km, 2 km, 1 km and 500 m, the intervals between the final locatable positions in the display area is about 4 cm in the scales 1, 2, 3 and 4.

The name-assigned link length calculating section 153 conducts a similar process to the number-assigned link length calculating section 151 in order to calculate a total length of the links L assigned with a common road name as a total link length that is an actual length of roads assigned with the common road name. In the description below, when links L assigned with a common road name are collectively mentioned, the links L are referred to as commonly-named links Ln. Specifically, the name-assigned link length calculating section 153 obtains the link information 210 corresponding to a predetermined link L from the link information table 200. When recognizing that a road name is stored in the route name information 217 of the link information 210, the name-assigned link length calculating section 153 recognizes the links L corresponding to the link information 210 as name-assigned links L corresponding to the link information 210. The name-assigned link length calculating section 153 calculates a length of the name-assigned links L as a subtotal link length of the commonly-named link Ln. When the predetermined link L is recognized to have the same road name as that of the name-assigned link L, the subtotal link length is calculated, while when the link L is recognized not to have the same road name as that of the name-assigned link L, the already-calculated subtotal link length is recognized as the total link length of the commonly-named link Ln.

The name location processing section 154 sets the locatable position of the annotation character string of the road name of the commonly-named link Ln, based on the total link length of the commonly-named links Ln having the predetermined road name, the locatable position of the existing annotation. Specifically, the name location processing section 154 judges whether or not the total link length of the commonly-named links Ln is longer than the first, second, third or fourth location interval. Herein, each location interval may be a different interval from the corresponding intervals of the commonly-numbered link Lb.

When judging that the total link length is longer than, for example, the first location interval, the name location processing section 154 recognizes that a plurality of the annotation character strings of the road names can be located in the vicinity of the commonly-named link Ln and sets the tentative locatable positions of the plurality of annotation character strings of the road names at the first interval on the commonly-named link Ln. When judging that the total link length is shorter than, for example, the first location interval, the name location processing section 154 recognizes that only one annotation character string of the road name can be located on the commonly-named link Ln and sets the tentative locatable position of the only one annotation character string of the road name at a predetermined position on the commonly-named link Ln. Note that, the tentative locatable positions may be located at positions apart from the commonly-named link Ln by a predetermined distance at the first interval.

Further, the name location processing section 154 recognizes the shape of the character area of the annotation character string of the predetermined road name and sets the character area of which shape is recognized so as to correspond to the tentative locatable position and so as to be aligned with but not to overlap on the commonly-named link Ln. For example, when an area G12 is displayed in the map scale of the scale 1 as shown in FIG. 12, a character area Hdz (z is a natural number) of a annotation character string Wdz (z is a natural number) of the road name is set so as to correspond to a tentative locatable position Daz (z is a natural number) and to overlap on the commonly-named link Ln. Herein, the commonly-named link Ln in the vicinity of the tentative locatable position Da1 is bending, so that a character area Hd1 is set to have a bending shape. The commonly-named links Ln in the vicinity of tentative locatable positions Da2, Da3 and Da4 are substantially straight, so that the character areas Hd1, Hd2 and Hd3 are set to have a rectangular shape. When areas G22, G32 and G42 as shown in FIG. 12 are displayed in the scale 2, 3 or 4, the character area of the annotation character string of the road name is also set in a similar manner.

When recognizing that there is an existing annotation relative to the annotation character string of the road name, the name location processing section 154 re-sets the tentative locatable position of the annotation character string of the road name to another position so as not to overlap on the overlapped existing annotation. And on setting the character area of the annotation character string so as to correspond to the tentative locatable position and to be aligned with but not overlap on the commonly-named link Ln and recognizing that there is no overlapped existing annotations, the name location processing section 154 sets the tentative locatable position as the final locatable position. The annotation character string Wdz of the road name located at the final locatable position is displayed on the display unit so as to be aligned with but not to overlap on the road corresponding to the commonly-named link Ln. As shown in FIG. 12, when recognizing that there is no overlapped existing annotations relative to the annotation character strings Wd1 to Wd4 of the road name respectively located at the tentative locatable positions Da1 to Da4, the name location processing section 154 sets the tentative locatable positions Da1 to Da4 as the final locatable positions. Note that, the interval between the final locatable positions of the road name is about 4 cm in the scales 1, 2, 3 and 4.

The annotation data generating section 155 uses the settings of the final locatable position of the annotation character string of the road number or the road name in order to generate the annotation data 170. Specifically, when recognizing a setting input for generating the annotation data 170 to display the road number, the annotation data generating section 155 operates the number-assigned link length calculating section 151 to calculate the total link length of the commonly-numbered links Lb having the predetermined road number. The annotation data generating section 155 judges whether or not the display type is set to the symbol display type in the scales 1, 2, 3 and 4. When the display type is judged to be the symbol display type, the annotation data generating section 155 operates the number location processing section 152 to set the final locatable position of the annotation character string of the road number in the scales. Note that, the setting of the display type may be made together with the setting input for generating the annotation data 170 of the road number, or may be set in advance.

The annotation data generating section 155 generates the annotation character-string information 182 storing the road number assigned to the commonly-numbered link Lb, the annotation character-number information 183 storing the number of the characters of the road number and the annotation type information 184 storing the information that the type is the road number. The annotation data generating section 155 also generates the scale 1 display type information 185, the scale 2 display type information 186, the scale 3 display type information 187 and the scale 4 display type information 188, each storing the set display type. The annotation data generating section 155 also selects a predetermined node N in connection with the commonly-numbered link Lb and recognizes the coordinates of the node N based on the node coordinate information 263 of the node information 260 that corresponds to the selected node N. The annotation data generating section 155 sets the position of the coordinates of the node N as the true position Pt (t is a natural number) of the commonly-numbered link Lb and generates the true-position shape information 189 corresponding to the true position Pt. For example, as shown in FIG. 7, the true point P11 is set to generate the true-position shape information 189. The annotation data generating section 155 then generates the annotation true-position data 180 incorporating the thus-generated plural pieces of information and the object ID information 181 arbitrarily set.

Further, the annotation data generating section 155 recognizes the coordinates of the final locatable positions in the scale 1, 2, 3 and 4 of the annotation character string of one road number and generates the character string shape information 194 by associating the coordinates and the information on the scale on which the annotation character string is displayed. Herein, when a plurality of final locatable positions is set for at least one scale out of the scales 1, 2, 3 and 4 i.e. when the annotation character strings of a plurality of road numbers are displayed, the annotation data generating section 155 generates the number of pieces of the display text string data 190 corresponding to the set final locatable position number. Specifically, for example, when four, eight, sixteen and thirty-two final locatable positions are respectively set in the scales 1, 2, 3 and 4, thirty-two pieces of character string shape information 194 are generated. Then, for example, the coordinates of the final locatable positions in the scales 1, 2, 3 and 4 are stored in the 1st, 2nd, 3rd and 4th character string shape information. The coordinates of the final locatable positions in the scales 2, 3 and 4 are respectively stored in the 5th to 8th character string shape information 194. The coordinates of the final locatable positions in the scales 3 and 4 are stored in the 9th to 16th character string shape information 194. The coordinates of the final locatable positions in the scale 4 are stored in the 17th to 32th character string shape information 194.

Note that, a following arrangement may be alternatively employed. When four, eight, sixteen and thirty-two final locatable positions are respectively set in the scales 1, 2, 3 and 4, the total number of the final locatable positions i.e. sixty pieces of character string shape information 194 may be generated. The final locatable positions in the scale 1 may be stored in the 1st to 4th character string shape information 194, the final locatable positions in the scale 2 in the 5th to 12th character string shape information 194, the final locatable positions in the scale 3 in the 13th to 28th character string shape information 194, and the final locatable positions in the scale 4 in the 29th to 60th character string shape information 194.

The annotation data generating section 155 generates the same number of pieces of the font size information 192 and the corresponding annotation character ID information 193 as that of the generated character string shape information 194. The annotation data generating section 155 generates the same number of pieces of the display text string data 190 as that of the character string shape information 194, the display text string data 190 incorporating the thus-generated plural pieces of information and the object ID information 191 arbitrarily set. Then, the annotation data generating section 155 generates the annotation data 170 incorporating the annotation true-position data 180 and at least one piece of the display text string data 190 and operates the storage section 130 to store the annotation data 170.

Specifically, when recognizing a setting input for generating the annotation data 170 to display the road name, the annotation data generating section 155 operates the name-assigned link length calculating section 153 to calculate the total link length of the commonly-named links Ln having the predetermined road name. The annotation data generating section 155 judges whether or not the display type is set to the character display type in the scales 1, 2, 3 and 4. When the display type is judged to be the character display type, the annotation data generating section 155 operates the name location processing section 154 to set the final locatable position of the annotation character string of the road name in the scales.

The annotation data generating section 155 generates the annotation character-string information 182 storing the road name assigned to the commonly-named link Ln, the annotation character-number information 183 storing the number of the characters of the road name and the annotation type information 184 storing the information that the type is the road name. The annotation data generating section 155 sets the position of the coordinates of the predetermined node N in connection with the name-assigned link L as the true position Ps (s is a natural number) of the commonly-named link Ln and generates the true-position shape information 189 corresponding to the true position Ps. For example, as shown in FIG. 12, the true point P21 is set to generate the true-position shape information 189. The annotation data generating section 155 then generates the annotation true-position data 180 incorporating the thus-generated plural pieces of information.

Further, the annotation data generating section 155 conducts a similar process to the generating process of the display text string data 190 corresponding to the road number and generates the number of pieces of display text string data 190 corresponding to the number of the final locatable positions of the annotation character string of the road name which is set by the name location processing section 154. Then, the annotation data generating section 155 generates the annotation data 170 incorporating the annotation true-position data 180 and at least one piece of the display text string data 190 and operates the storage section 130 to store the annotation data 170.

[Operation of Map Information Generator]

Next, how the map information generating device 100 operates will be described with reference to the attached drawings.

(Generating Process of Note Data relating to Road Number)

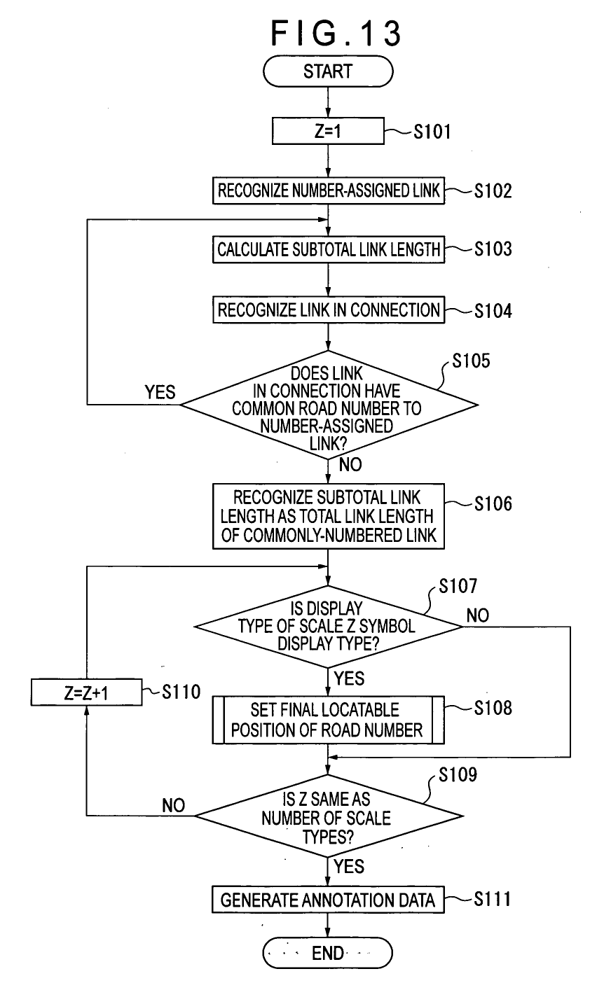

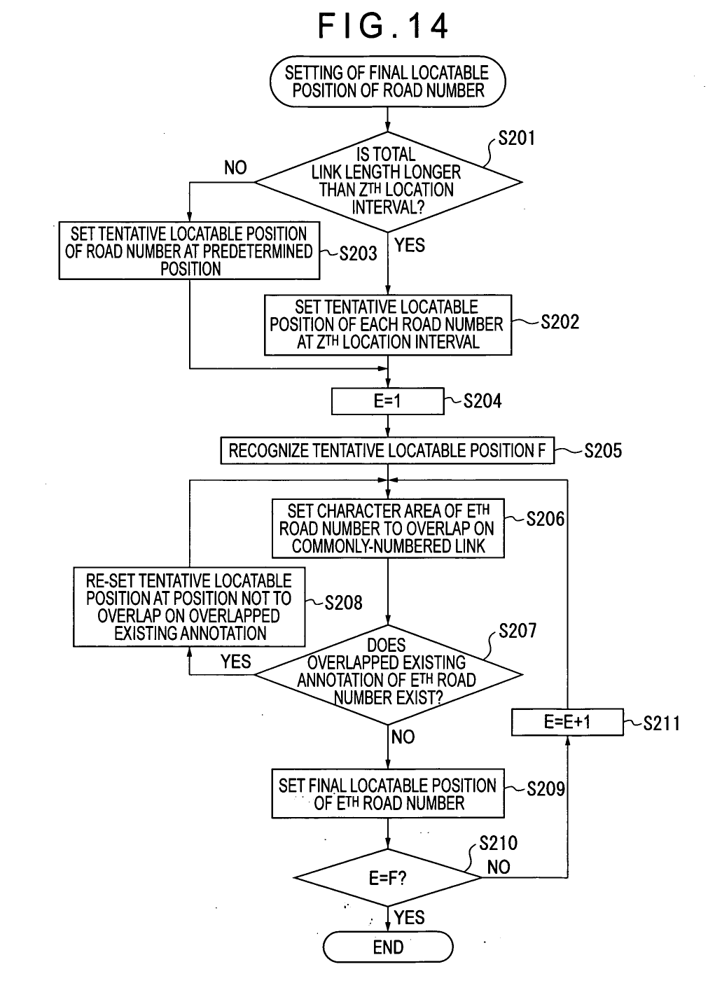

The operation of the map information generating device 100 i.e. how the annotation data 170 relating to the road number is generated will be explained based on FIGS. 13 and 14. FIG. 13 is a flowchart showing a generating process of the annotation data relating to the road number. FIG. 14 is another flowchart showing a setting process of the final locatable position of the road number.

As shown in FIG. 13, the processor 150 of the map information generating device 100 sets a variable to 1, when the annotation data generating section 155 recognizes a setting input for generating the annotation data 170 for displaying the road number (step S101). The processor 150 operates the number-assigned link length calculating section 151 to recognize the number-assigned link L (step S102) and to calculate the subtotal link length of the commonly-numbered links Lb (step S103). Subsequently, the number-assigned link length calculating section 151 recognizes the link L (step S104) in the connection therewith, and judges whether or not the link L has the common road number to that of the number-assigned link L (step S105).

In step S105, when the number-assigned link length calculating section 151 judges that the link L has the common road number to that of the number-assigned link L, the process of step S103 is conducted. On the other hand, when judging that the link L does not have the common road number to that of the number-assigned link L in step S105, the number-assigned link length calculating section 151 recognizes the subtotal link length at this time point as the total link length of the commonly-numbered link Lb (step S106). Next, the annotation data generating section 155 judges whether or not the display type of a scale Z is set to the symbol display type (step S107). In step S107, when the display type is judged to be the symbol display type, the processor 150 processes the setting of the final locatable position of the road number (step S108).

After the process of the final locatable position setting in step S108 or after judging that the display type is not set to the symbol display type in step S107, the annotation data generating section 155 judges whether or not a variable Z is the number same as that of the scale types i.e. four (step S109). In step S109, when being judged not to be the same as the number of the scale types, the variable Z is added with one (step S110), and the process of step S107 is conducted. On the other hand, in step S109, when the variable Z is judged to be the same as the number of the scale types, the annotation data 170 is generated based on the final locatable position of the road number set in the process of step S108 (step S111), and then stored in the storage section 130, ending the whole process.

As for a process for setting the final locatable position of the road number, as shown in FIG. 14, the processor 150 operates the number location processing section 152 to judge whether or not the total link length of the commonly-numbered links Lb is longer than a Z^{th} location interval (step S201). In step S201, when the total link length is judged to be longer than the Z^{th} location interval, the tentative locatable position of the road number is set for each of the Z^{th} location intervals (step S202). In step S201, when the total link length is judged to be shorter than the Z^{th} location interval, the tentative locatable position of the road number is set to a predetermined position on the commonly-numbered link Lb (step S203). After processing the setting of the tentative locatable positions in step S202 or 203, the number location processing section 152 sets a variable E to 1 (step S204) and recognizes a tentative locatable position number F being set (step S205). The number location processing section 152 sets a character area of an E^{th} road number, for example a character area of the road number having the tentative locatable position that is the E^{th} nearest from the start point of the commonly-numbered link Lb, so as to overlap on the commonly-numbered link Lb (step S206). Subsequently, whether or not there is any overlapped existing annotation on the E^{th} road number is judged (step S207).

In step S207, when judging that there is an overlapped existing annotation, the tentative locatable position of the E^{th} road number is tentatively set at a position so as not to overlap on the overlapped existing annotation (step S208), and the process of step S206 is conducted. In step S207, when judging that there is no overlapped existing annotation, the tentative locatable position of the E^{th} road number is set as the final locatable position (step S209), and whether or not the variable E is the same as the tentative locatable position number F is judged (step S210). In step S210, when judging that the variable E is the same as the tentative locatable position number F, the process is ended. In step S210, when judging that the variable E is not the same as the tentative locatable position number F, the variable E is added with one (step S211), and the process of step S206 is conducted.

(Generating Process of Note Data relating to Road Name)

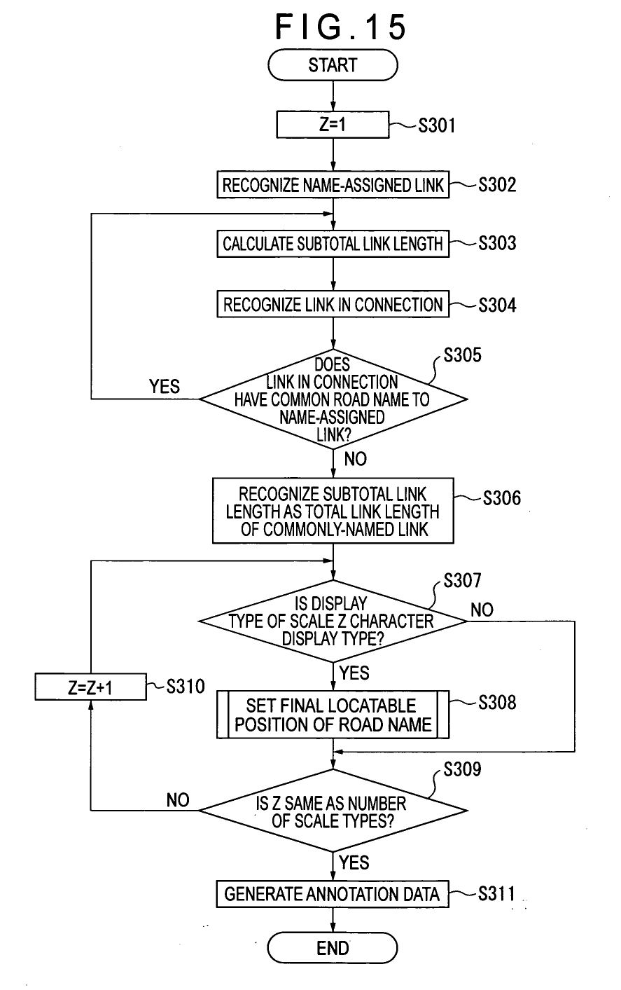

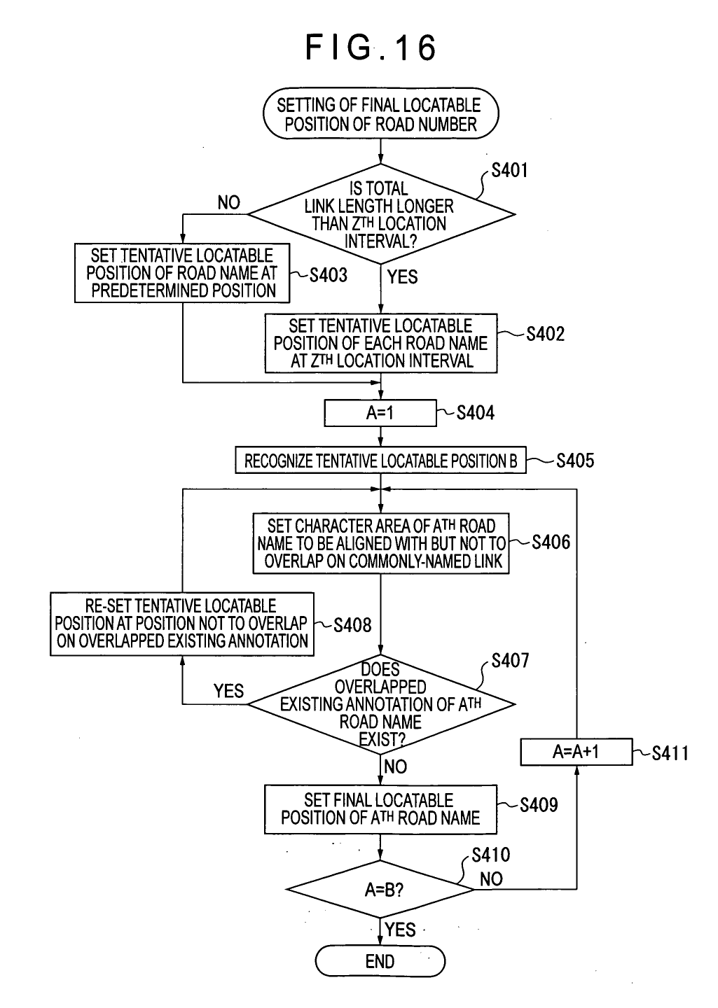

The operation of the map information generating device 100 i.e. how the annotation data 170 relating to the road name is generated will be explained based on FIGS. 15 and 16. FIG. 15 is a flowchart showing a generation process of the annotation data relating to the road name. FIG. 16 is another flowchart showing a setting process of the final locatable position of the road name.

As shown in FIG. 15, the processor 150 of the map information generating device 100 sets a variable Z to 1, when the annotation data generating section 155 recognizes a setting input for generating the annotation data 170 for displaying the road name (step S301). The name-assigned link length calculating section 153 recognizes the name-assigned link L (step S202), and calculates the subtotal link length of the commonly-named links Ln (step S303). Subsequently, the name-assigned link length calculating section 153 recognizes the connected link L (step S304), and judges whether or not the link L in the connection with the name-assigned link L has the common road name to that of the name-assigned link L (step S305).

In step S305, when the name-assigned link length calculating section 151 judges that the link L has the common road name to that of the name-assigned link L, the process of step S303 is conducted. On the other hand, when judging that the link L does not have the common road name to that of the name-assigned link L in step S305, the name-assigned link length calculating section 153 recognizes the subtotal link length as the total link length of the commonly-named links Ln (step S306), and judges whether or not the display type of the scale Z is set to the character display type (step S307). In step S307, when the display type is judged to be the character display type, the processor 150 performs the setting of the final locatable position of the road number (step S308).

After the process of the final locatable position setting of the road name in step S308 or after judging that the display type is not set to the character display type in step S307, the processor 150 judges whether or not the variable Z is the number same as the number of the scale types (step S309). In step S309, when being judged not to be the same as the number of the scale types, the variable Z is added with one (step S310), and the process of step S307 is conducted. On the other hand, in step S309, when the variable Z is judged to be the same as the number of the scale types, the annotation data 170 is generated based on the final locatable position of the road name set in the process of step S308 (step S311), and then stored in the storage section 130, ending the whole process.

As for a process for setting the final locatable position of the road name, as shown in FIG. 16, the processor 150 operates the name location processing section 154 to judge whether or not the total link length of the commonly-named links Ln is longer than a Z^{th} location interval (step S401). In step S401, when the total link length is judged to be longer than the Z^{th} location interval, the tentative locatable position of the road name is set for each of the Z^{th} location intervals (step S402). In step S401, when the total link length is judged to be shorter than the Z^{th} location interval, the tentative locatable position of the road name is set to a predetermined position on the commonly-named link Ln (step S403). After the process of step S402 or 403, the name location processing section 154 sets the variable A to 1 (step S404) and recognizes a tentative locatable position number B being set (step S405). The character area of an A^{th} road name is set so as to be aligned with but not to overlap on the commonly-named link Ln (step S406), and whether or not there is any overlapped existing annotation relative to the A^{th} road name is judged (step S407).

In step S407, when judging that there is an overlapped existing annotation, the tentative locatable position of the A^{th} road name is re-set at a position not overlapping on the overlapped existing annotation (step S408), and the process of step S406 is conducted. In step S407, when judging that there is no overlapped existing annotation, the tentative locatable position of the A^{th} road name is set as the final locatable position (step S409), and whether or not the variable A is the same as the tentative locatable position number B is judged (step S410). In step S410, when judging that the variable A is the same as the tentative locatable position number B, the process is ended. In step S410, when judging that the variable A is not the same as the tentative locatable position number B, the variable B is added with one (step S411), and the process of step S406 is conducted.

[Effects and Advantages of Map Information Generating Device]

As described above, the map information generating device 100 has following advantages in the embodiment. Advantages in setting the locatable position of the road number will be mainly explained below, but similar advantages can be also obtained in setting the locatable position of the road name.

The processor 150 of the map information generating device 100 recognizes the commonly-numbered link Lb assigned with a common road number by the number-assigned link length calculating section 151. The processor 150 operates the number location processing section 152 to set the final locatable positions of the road number in the scales 1, 2, 3 and 4 at positions so as to be aligned with the commonly-numbered link Lb and such that at least one annotation character string can be displayed in the display area with roads. The processor 150 operates the annotation data generating section 155 to use the settings of the final locatable position by the number location processing section 152 to generate the annotation data 170, and operates the storage section 130 the generated annotation data 170. Hence, the map information generating device 100 does not require the creator of the annotation list data 160 to set the locatable positions for each of the annotation character strings of the road numbers, eliminating bothersome setting inputs by the creator, and can generate the annotation data 170 for appropriately displaying the road numbers. The final locatable position of the annotation character string of the road number is set at the position such that at least one annotation character string is displayed in the scales 1, 2, 3 and 4, thereby preventing a problem in which a predetermined area is displayed in an enlarged manner and the interval between the road numbers accordingly widens, so that no road number is displayed in the display area. The road numbers can be displayed without employing an arrangement for recognizing the present position of the vehicle in addition to the arrangement for displaying the road numbers using the annotation list data 160. As compared with the arrangement in which the road numbers of the link information table 200 and the annotation list data 160 are respectively input by its own creator, there will not be a problem in which different creators input different road numbers for a certain link information 210 or annotation data 170 that corresponds to a road having one road number. Hence, the map information generating device 100 can generate the annotation data 170 for displaying the road number together with the roads that are displayed in different scales.

The annotation data generating section 155 generates, as data for displaying road numbers, the annotation data 170 that has the annotation character-string information 182 for displaying the annotation character string of the road number and the character string shape information 194 for showing the position of the character area of the annotation character string displayed by the annotation character-string information 182. Hence, for example, when a road having a predetermined road number is extended, the data update for displaying the road number can be easier as compared with the arrangement for generating image data for displaying one image, in which a plurality of annotation character strings of the road number are located at predetermined positions.

On recognizing that a common road number is stored in the national/prefectural road number information 216 corresponding to the plurality of links L that represent a road, the number-assigned link length calculating section 151 judges that the plurality of links L are the commonly-numbered links Lb i.e. that the plurality of links L represent the road assigned with one common road number. Hence, it is possible to identify the road assigned with the common road number only by referring to the national/prefectural road number information 216.

The number location processing section 152 sets the final locatable positions of the annotation character strings of the road numbers in, for example, the scale 1 at the first location interval. Hence, unlike the arrangement in which the final location interval is set different from each other, there will not be a problem such as that too many road numbers are displayed in a part of the display area or the interval between the road numbers is too long. Thus, as compared with the arrangement in which the final location interval is set different from each other, it is possible to generate the annotation data 170 that enables a user to easily recognize the road numbers.

The map information generating device 100 sets the final locatable positions of the road numbers in all of the scales 1, 2, 3 and 4 at the interval of about 4 cm. Hence, it is possible to generate the annotation data 170 to display the road numbers at a substantially common display interval in the scales 1, 2, 3 and 4, thereby enabling the user to visually recognize the road numbers shown in the different scales with ease. Thus, the map information generating device 100 can generate the annotation data 170 for displaying the road numbers more appropriately.

When judging that the total link length of the commonly-numbered links Lb is longer than, for example, the first location interval, the number location processing section 152 sets a plurality of the final locatable positions of the road numbers so as to be aligned with the commonly-numbered links Lb. Thus, since how may final locatable positions can be set can be recognized before setting, the process can be more efficient as compared with the arrangement in which the final locatable positions are set by judging whether or not the character area is positioned apart form the preset locatable position by the first location interval.

When judging that the total link length is shorter than the first location interval, the number location processing section 152 sets only one final locatable position of the road number to be aligned with the commonly-numbered link Lb. Hence, even when the total link length of the commonly-numbered link Lb is shorter than the first location interval, it is possible to generate the annotation data 170 for displaying the road number. Thus, it is possible to provide the map information generating device 100 that can generate more convenient annotation data 170 as compared with the arrangement in which the final locatable position of the road number is not set when, for example, the total link length is shorter than the first location interval i.e. the arrangement for generating the annotation data 170 for not displaying the road number.

The number-assigned link length calculating section 151 recognizes the nodes N respectively located at the start and end points of the commonly-numbered link Lb based on the start node ID information 214 and the end node ID information 215, and calculates the total link length of the commonly-numbered links Lb based on the node coordinate information 263 of the thus-recognized nodes N. Hence, the total link length can be recognized more easily as compared with the calculation based on the coordinates of the nodes N of the commonly-numbered link Lb.

When recognizing that there is an existing annotation relative to the annotation character string of the road name, the number location processing section 152 re-sets the tentative locatable position of the annotation character string of the road number to another position so as not to overlap on the overlapped existing annotation. Thus, it is possible to generate the annotation data 170 for displaying the road numbers with no overlapping on other annotations, thereby enhancing the convenience of the map information generating device 100.

The number location processing section 152 sets the final locatable position of the road number to be displayed on a predetermined graphic to a position on the commonly-numbered link Lb. Hence, the map information generating device 100 can generate the annotation data 170 for displaying the road number in a similar display manner to general road maps, thereby enabling the user to visually recognize the road numbers without feeling incongruity.

The name location processing section 154 sets the final locatable position of the road name to a position so as not to overlap on the commonly-named link Ln. Hence, the map information generating device 100 can generate the annotation data 170 for displaying the road name in a similar display manner to general road maps, thereby enabling the user to visually recognize the road names without feeling incongruity. Further, it is possible to generate the annotation data 170 that can reliably prevent a problem in which the road names overlap on the commonly-named links Ln, making it difficult to recognize the road names.

When the commonly-named link Ln is bending, the name location processing section 154 sets the character area of the road name in a bending shape such that a distance between each character and the commonly-named link Ln is substantially the same. Accordingly, even when the commonly-named link Ln has a bending shape, the user can recognize the road name more surely as compared with the arrangement in which the character area of the road name is set in a rectangular shape i.e. the character area is set such that the distance between the characters and the commonly-named link Ln is not unique. Hence, it is possible to provide the map information generating device 100 that ca generate the annotation data 170 of higher convenience.

The information generating device is applied to the map information generating device 100 for generating the annotation data 170 displayed together with the road number on the display unit. Hence, the map information generating device 100 can generate the annotation data 170 capable of displaying the road number at an appropriate position on the map, thereby enabling the user to appropriately recognize the road number of a predetermined road.

The information generating device of the invention is applied to the map information generating device 100 for generating the annotation data 170 for displaying the road number or the road name on the display unit mounted in the vehicle. Hence, even with the display unit mounted in the mobile body having a smaller display area than that of the display unit mounted at home, the annotation data 170 can be updated such that the road number is displayed at an appropriate position, thereby further enhancing the convenience of the map information generating device 100.

### Modifications of Embodiments

It should be noted that the present invention has been described above with reference to the embodiment, the scope of the invention is not limited thereto and includes various modifications as long as an object of the present invention can be achieved. Modifications in setting the locatable position of the road number will be mainly explained below, but similar modifications can be also employed in setting the locatable position of the road name.

The number-assigned link length calculating section 151 may judge that a plurality of links L represent a road assigned with a common road number, based on a setting input for selecting the plurality of links L by the user as the commonly-numbered link Lb. With such arrangement, the number-assigned link length calculating section 151 does not need to have a function for recognizing the details of the national/prefectural road number information 216, thereby making the arrangement of the number-assigned link length calculating section 151 simpler.

The road names in, for example, the scale 1 may be displayed at different intervals therebetween, or a length displayed in the display area may not be unique but vary in the first to fourth location intervals, as long as at least one annotation character string is displayed in the display area together with the roads so as to be aligned with the commonly-numbered link Lb. The number location processing section 152 may set the final locatable position of the road number at a position so as not to overlap on the commonly-numbered link Lb. The name location processing section 154 may set the final locatable position of the road name to a position overlapping on the commonly-named link Ln. Even with these arrangements, the creator of the annotation list data 160 does not need to input bothersome settings such as the locatable positions of the annotation character strings of the road number for the map information generating device 100. Even when a predetermined area is displayed in an enlarged manner, the problem in which the road number is not displayed in the display area due to the widened intervals of the road numbers can be prevented. The road numbers can be displayed without employing an arrangement for recognizing the present position of the vehicle to the arrangement for displaying the road numbers using the annotation list data 160. Thus, the map information generating device 100 can appropriately generate the annotation data 170 for displaying the road numbers at positions substantially corresponding to each roads.

The number location processing section 152 may set the character area by judging whether or not the character area is positioned apart from the preset locatable position by, for example, the first location interval as moving the character area of the road number along the commonly-numbered link Lb. With such arrangement, the number-assigned link length calculating section 151 does not need to have a function for calculating the total ling length of the commonly-numbered link Lb, thereby making the arrangement of the number-assigned link length calculating section 151 simpler.

When judging that the total link length is shorter than, for example, the first location interval, the setting process of the final locatable position of the road number may be ended without setting the final locatable position of the road number. With such arrangement, load in the setting process of the final locatable position of the road can be reduced. The annotation data 170 that can reduce information amount to be displayed in the display area, thereby enabling the user to easily recognize various kinds of information visually.

The number-assigned link length calculating section 151 may recognize the total link length based on the setting input of the total link length of the commonly-numbered link Lb by the user. With such arrangement, the number-assigned link length calculating section 151 does not need to have a function for calculating the total ling length of the number-assigned link length calculating section 151, thereby making the arrangement of the number-assigned link length calculating section 151 simpler.

The number location processing section 152 may not have a function for re-setting the tentative locatable position of the road number to a position so as not to overlap on the overlapped existing annotation. Accordingly, the arrangement of the number location processing section 152 can be simple. In addition, load in the setting process of the final locatable position of the road number can be reduced.

The processor 150 may not be provided with the number-assigned link length calculating section 151 and the number location processing section 152, or may not be provided with the name-assigned link length calculating section 153 and the name location processing section 154. Accordingly, the arrangement of the processor 150 can be simple.

The name location processing section 154 may set the character area of the road name in a bending shape not in a rectangular shape, even when the commonly-named link Ln is bending. With such arrangement, the name location processing section 154 does not need to have a function for setting the character area in a bending shape, thereby making the arrangement of the name location processing section 154 simpler.

An arrangement in which the image data for displaying one image on which a plurality of annotation character strings of the road numbers are located at predetermined positions may be employed. It is not limited to the annotation data 170 for displaying the road numbers and the road names, but an arrangement for generating moving-path-related information used to display details of a predetermined moving path is also employed such as that in which traffic-line-related information for displaying route names and route numbers of trains and buses, road connected place name information for displaying place names that are connected to roads, circuit diagram information for displaying numbers and names assigned to wirings as moving paths constituting the circuit diagram or the like are generated. An aspect of the present invention may be applied to an arrangement for generating the above mentioned information of a map or a circuit diagram which is to be printed out on paper. The display unit for displaying maps are not limited to those to be mounted in the mobile body, but may include those mounted at home or factories. The information generating device of the invention may have the processor 150 as an independent part.

The information generating device of the invention may be applied to, for example, navigation devices and computers for displaying maps in order to display the road number together with the road by setting the final locatable position of the road number to a position such that the road number is positioned along the common number link Lb and at least one road number is displayed in relation with the area to be displayed in the display area.

The functions described above are made as programs but may be any form such as a hardware including a circuit board, or an element including an IC (Integrated Circuit), either being usable. Note that, the arrangement in which the functions are read from the programs or other recording media makes handling easier, thereby easily expanding its usability.

In addition, concrete structures and procedures in embodying the present invention can be changed to different structures and others as long as an object of the invention can be achieved.

### Advantages of Embodiments

As described above, in the above embodiment, the processor 150 of the map information generating device 100 sets the final locatable position of the annotation character string of the road number in the scales 1, 2, 3 and 4 at a position so as to be aligned with the commonly-numbered link Lb recognized to have a common road number and such that at least one annotation character string is displayed in the display area with roads. The processor 150 generates the annotation data 170 by applying the settings of the final locatable positions of the annotation character strings of the road number and operates the storage section 130 to store the generated annotation data 170. Hence, the map information generating device 100 does not require a creator of the annotation list data 160 to set the locatable positions for each of the annotation character strings of the road numbers, eliminating bothersome setting inputs by the creator, and can generate the annotation data 170 for appropriately displaying the road numbers. Since the final locatable position of the annotation character string of the road number is set at a position such that at least one annotation character string is displayed in the scales 1, 2, 3 and 4, a problem in which a predetermined area is displayed in an enlarged manner and the interval between the road numbers widens, so that no road number is displayed in the display area. The road numbers can be displayed without employing an arrangement for recognizing a present position of a vehicle to the arrangement for displaying the road numbers using the annotation list data 160. Hence, the map information generating device 100 can generate the annotation data 170 for displaying the road number together with the roads that are displayed in different scales.

The priority application Number JP2005-150175 upon which this patent application is based is hereby incorporated by reference.

What is claimed is:

1. An information generating device for generating moving-path-related information for displaying moving path detail information relating to details of a moving path, the moving path detail information displayed relative to the moving path that is displayed in different scales in a display area, comprising:
an identifying section for identifying the moving path of which details are shown by the predetermined moving path detail information;
a moving path position recognizer for recognizing a display position in the different scales of the moving path identified by the identifying section;
a detail position setting section for setting the display position in the different scales of the moving path detail information of the moving path identified by the identifying section such that at least one of the moving path detail information is aligned and displayed with the moving path in the display area; and
a moving-path-related information generating section for generating the moving-path-related information for displaying the moving path detail information at the display position set by the detail position setting section.

2. The information generating device according to claim 1, further comprising:
a detail position information generating section for generating detail position information relating to the display position of the moving path detail information set by the detail position setting section, wherein
the moving-path-related information generating section generates the moving-path-related information having the moving path detail information and the detail position information.

3. The information generating device according to claim 1, wherein
the moving path is represented by a plurality of links connected to each other with nodes therebetween, each node representing a predetermined site point,
each link of the plurality of links is associated with the moving path detail information of the moving path that the link represents, and
when recognizing that the moving path detail information of each of the plurality of links is the same, the identifying section for identifying the moving path identifies the moving path represented by the plurality of links as the moving path of which details are shown by the predetermined moving path detail information.

4. The information generating device according to claim 1, wherein
the detail position setting section sets the display position of the moving path detail information at a predetermined interval.

5. The information generating device according to claim 4, wherein
the predetermined interval is the same in all the different scales.

6. The information generating device according to claim 4, further comprising:
a moving path length recognizer for recognizing a length of the moving path identified by the identifying section for identifying the moving path, wherein
when recognizing the length of the moving path which is recognized by the moving path length recognizer is longer than a length of the moving path corresponding to the predetermined interval, the detail position setting section sets the display position of the moving path detail information at the predetermined interval.

7. The information generating device according to claim 6, wherein
when recognizing the length of the moving path which is recognized by the moving path length recognizer is shorter than the length of the moving path corresponding to the predetermined interval, the detail position setting section sets the display position of the moving path detail information at a position along the moving path.

8. The information generating device according to claim 6, wherein
the moving path is represented by the plurality of links connected to each other with the nodes therebetween, each node representing a predetermined site point,
the node is associated with coordinate information of coordinates of the display position of the site point corresponding to the node,
the link is associated with connection node identification information for identifying the node connecting the link to another link, and
the moving path length recognizer identifies the nodes provided at ends of the plurality of links based on the connection node identification information of the plurality of links that represent the moving path identified by the identifying section for identifying the moving path, and recognizes the length of the moving path by calculating a total length of the plurality of links based on the coordinate information of the identified nodes.

9. The information generating device according to claim 1, wherein
when recognizing that the moving path detail information displayed at the set display position overlaps on target object detail information relating to details of a target object, the target object detail information displayed so as to correspond to a position of the target object that exist at a predetermined position, the detail position setting section sets the display position of the moving path detail information to another position so as not overlap on the target object detail information.

10. The information generating device according to claim 1, wherein
the moving path detail information is information for displaying a number representing the moving path so as to superimpose on a predetermined graphic, and
the detail position setting section sets the display position of the moving path detail information at a position so as to superimpose on the moving path.

11. The information generating device according to claim 1, wherein
the moving path detail information is information for displaying a name of the moving path, and
the detail position setting section sets the display position of the moving path detail information at a position so as not to superimpose on the moving path.

12. The information generating device according to claim 11, wherein
when recognizing that a name of the moving path is shown by a plurality of characters, the detail position setting section sets the display position of the moving path detail information such that a distance from each of the plurality of characters to the moving path is the same.

13. The information generating device according to claim 1, wherein
the moving path is a road on which a mobile body can move.

14. The information generating device according to claim 13, wherein
the moving path detail information is information for displaying details of the road relative to the road displayed in the display area of a display unit mounted in the mobile body.

15. An information generating method for generating moving-path-related information for displaying moving path detail information relating to details of a moving path, the moving path detail information displayed relative to the moving path that is displayed in different scales in a display area with a computing unit, comprising:
identifying the moving path of which details are shown by the moving path detail information,
recognizes a display position of the identified moving path in the different scales,
setting the display position of the moving path detail information of the identified moving path in the different scales at a position such that at least one of the moving path detail information is aligned and displayed with the moving path, and
generating the moving-path-related information for displaying the moving path detail information at the set display position.

16. An information generating program stored in a storing medium in a readable manner by a computing unit, the program operating the computing unit to function as an information generating device for generating moving-path-related information for displaying moving path detail information relating to details of a moving path, the moving path detail information displayed relative to the moving path that is displayed in different scales in a display area, wherein
the information generating device has:
an identifying section for identifying the moving path of which details are shown by the predetermined moving path detail information;
a moving path position recognizer for recognizing a display position in the different scales of the moving path identified by the identifying section;
a detail position setting section for setting the display position in the different scales of the moving path detail information of the moving path identified by the identifying section; and
a moving-path-related information generating section for generating the moving-path-related information for displaying the moving path detail information at the display position set by the detail position setting section.

17. An information generating program stored in a storing medium in a readable manner by a computing unit, the program operating the computing unit to execute an information generating method for generating moving-path-related information for displaying moving path detail information relating to details of a moving path, the moving path detail information displayed relative to the moving path that is displayed in different scales in a display area with a computing unit, wherein
the information generating device has the computing unit to perform:
identifying the moving path of which details are shown by the moving path detail information,
recognizing a display position of the identified moving path in the different scales,
setting the display position of the moving path detail information of the identified moving path in the different scales at a position such that at least one of the moving path detail information is aligned and displayed with the moving path, and
generating the moving-path-related information for displaying the moving path detail information at the set display position.

18. A storing medium storing an information generating program in a readable manner by a computing unit, the program operating the computing unit to function as an information generating device for generating moving-path-related information for displaying moving path detail information relating to details of a moving path, the moving path detail information displayed relative to the moving path that is displayed in different scales in a display area, wherein
the information generating device has:
an identifying section for identifying the moving path of which details are shown by the predetermined moving path detail information;
a moving path position recognizer for recognizing a display position in the different scales of the moving path identified by the identifying section;
a detail position setting section for setting the display position in the different scales of the moving path detail information of the moving path identified by the identifying section such that at least one of the moving path detail information is aligned and displayed with the moving path in the display area; and
a moving-path-related information generating section for generating the moving-path-related information for displaying the moving path detail information at the display position set by the detail position setting section.

19. A storing medium storing an information generating program in a readable manner by a computing unit, the program operating the computing unit to execute an information generating method for generating moving-path-related information for displaying moving path detail information relating to details of a moving path, the moving path detail information displayed relative to the moving path that is displayed in different scales in a display area, wherein
the information generating device has the computing unit to perform:
identifying the moving path of which details are shown by the moving path detail information,
recognizing a display position of the identified moving path in the different scales,
setting the display position of the moving path detail information of the identified moving path in the different scales at a position such that at least one of the moving path detail information is aligned and displayed with the moving path, and
generating the moving-path-related information for displaying the moving path detail information at the set display position.
